(19) United States
(12) Patent Application Publication
(10) Pub. No.: US 2022/0005637 A1
(43) Pub. Date: Jan. 6, 2022

(54) Method for preparing high-performance sintered NdFeB magnets and sintered NdFeB magnets

(71) Applicant: Yantai Shougang Magnetic Materials Inc, Yantai (CN)

(72) Inventors: Xiulei CHEN, Yantai (CN); Zhongjie PENG, Yantai (CN); Zhanji DONG, Yantai (CN); Kaihong DING, Yantai (CN)

(21) Appl. No.: 17/367,660

(22) Filed: Jul. 6, 2021

(30) Foreign Application Priority Data
Jul. 6, 2020 (CN) 202010642162.0

(51) Int. Cl. H01F 1/153; H01F 1/053; H01F 1/057

(52) U.S. Cl. CPC H01F 1/15341; H01F 7/021; H01F 1/0577; H01F 1/0536

(57) ABSTRACT

The present disclosure relates to a method for preparing high-performance sintered NdFeB magnets. The method comprises the steps of: a) attaching a multi-element alloy powder onto a surface of the sintered NdFeB magnet, wherein the multi-element alloy is of formula (1) PrₐRH_{b}Ga_{c}Cu_{d} (1) with RH being at least one element selected from Dy and Tb and a, b, c, and d satisfying the conditions 0.30≤(a+b)/(a+b+c+d)≤0.65, 0.20≤d/(c+d)≤0.50, and 0.23≤b/(a+b)≤0.60; and b) performing a diffusion process.

### CROSS REFERENCE TO RELATED APPLICATION

This application claims priority to Chinese application serial number CN 202010642162.0 filed on Jul. 6, 2020, the entire content of which is incorporated in this application by reference.

### TECHNICAL FIELD

The present disclosure relates to a method for preparing high-performance sintered NdFeB magnets as well as to high-performance sintered NdFeB magnets, which are prepared by said method.

### BACKGROUND

NdFeB magnetic materials have a wide range of applications as one of the most excellent commercially available magnetic materials at present. High magnet performance and low manufacturing costs are the drivers in the industrial development of NdFeB magnets. The magnets shall withstand harsh operating conditions and the resource consumption should be as small as possible. In order to achieve the goal of low cost and high performance, optimization of the types and amounts of trace elements, fine powder technology and low oxygen technology are widely used in industry.

In particular, a heavy rare earth diffusion technology has also become an important and effective way to improve the performance of sintered NdFeB magnets in the recent years. At present, the most common thermal diffusion processes use heavy rare earth fluoride or hydride powders for diffusion or heavy rare earth alloy organic solution for coating and spraying, etc. In order to improve the diffusion effect and reduce the costs for raw materials, new diffusion sources and diffusion methods have been developed in the recent years.

CN 105513734 A discloses a method for preparing NdFeB magnets using a thermal diffusion process. The sintered NdFeB magnets are heat-treated with a powder including 2 to 20 parts by weight of a light rare earth element, 78 to 98 parts by weight of heavy rare earth element and 0 to 2 parts by weight of M, where M is one or more selected from the group consisting of Al, Cu, Co, Ni, Zr and Nb. The powder has a particle size of 1 to 20 μm. This increases the process cost and may also increase the oxygen content. Increasing of oxygen content will lead a deterioration of diffusion.

CN 105355353 A discloses the use of heavy rare earth amorphous alloys for thermal diffusion treatment of sintered NdFeB magnets. However, the diffusion depth of heavy rare earth elements is low and further improvement of coercivity is thereby inhibited.

US 2018/047504 A1 describes another exemplary diffusion process using an alloy including Ga, Cu and 65-95 mol. % of R2, where R2 is at least one rare-earth element which always includes Pr and/or Nd and [Cu]/([Ga]+[Cu]) is not less than 0.1 and not more than 0.9 by mole ratio.

Conventional diffusion methods using pure heavy rare earths or heavy rare earth hydrides and fluorides can easily lead to an enrichment of heavy rare earth elements in an area closed to the surface of the magnet, while no diffusion element or only low concentrations of the diffusion elements is present in deeper areas of the magnet. However, such a microstructure cannot suppress magnetic exchange coupling well. At the same time, due to the higher concentration of diffused elements in the region closer to the diffusion surface, the heavy rare earth will penetrate into the main phase grains, resulting in a significant reduction of remanence. And this will also cause the heavy rare earth elements to be consumed too quickly. The concentration of heavy rare earths drops sharply with the depth increasing, which can result in inhomogeneity in composition and structure. Finally, further improvement of performance is prevented.

### SUMMARY

The purpose of the disclosure is to overcome the deficiency of the existing technology and provide a method for preparing high performance sintered NdFeB magnets and sintered NdFeB magnets.

According to one aspect of the present invention, there is provided a method for preparing high-performance sintered NdFeB magnets comprising the steps of:

a) attaching a multi-element alloy powder onto a surface of the sintered NdFeB magnet, wherein the multi-element alloy is of formula (1)

PrₐRH_{b}Ga_{c}Cu_{d} (1)

with RH being at least one element selected from Dy and Tb and
a, b, c, and d satisfying the conditions 0.30≤(a+b)/(a+b+c+d)≤0.65, 0.20≤d/(c+d)≤0.50, and 0.23≤b/(a+b)≤0.60; and
b) performing a diffusion process.

According to the present disclosure, a multi-element alloy is used as diffusion source. Pr, Cu, and Ga elements in the alloy, which have low melting point, can easily penetrate into the magnets and have large diffusion depth even at low temperature. After Pr, Cu, and Ga enters the grain boundaries and triangle regions, the infiltration of heavy rare earth elements becomes relatively easy, i.e. infiltration speed is fastened and the diffusion depth is increased.

The infiltration of Pr and heavy rare earth elements can partially replace the Nd2Fe14B on the periphery of the main phase grains and form Pr2Fe14B and Dy2Fe14B/Tb2Fe14B shell structures with higher magnetocrystalline anisotropy fields outside the original main phase grains. This can significantly improve the coercivity of the magnet. The substitution of Pr and Dy/Tb occurs on the edge of the main phase particles and thereby avoids penetration into the centre of the main phase grains, so the remanence of the magnet will not decrease too much. The diffusion ability of Pr is stronger than that of Dy/Tb, so Pr element can effectively diffuse to the grain boundary even at low temperature or in a short time. The Pr2Fe14B formed at the periphery of the main phase grains can inhibit subsequent diffusion into the main phase centre of heavy rare earth elements, but may only form a shell layer on the periphery, which increases Ha coercivity. This type of microstructure avoids excessive reduction of remanence. At the same time, the infiltration of Cu and Ga can also inhibit the magnetic exchange coupling between the main phase grains and thereby the coercivity is further improved.

According to one embodiment, in the diffusion process of step b) a diffusion temperature is in the range of 720° C. to 980° C. for a period of 5 to 25 hours.

According to a further embodiment, which could be combined with the preceding embodiment, step b) is (directly) followed by step c) of performing an aging process. In the aging process of step c) an aging temperature may be in the range of 480° C. to 680° C. for a period of 1 to 10 hours.

According to another embodiment, which could be combined with any of the preceding embodiments, an average particle size of the multi-element alloy powder is in the range of 10 μm to 1000 μm, in particular 50 μm to 600 μm.

According to another embodiment, which could be combined with any of the preceding embodiments, is the multi-element alloy powder attached to a surface which perpendicular to the (magnetic) orientation direction of the sintered NdFeB mag net.

By controlling the particle size of the diffusion alloy and restricting its adhesion surface, which is perpendicular to the orientation direction, efficiency and effectiveness can be further improved. Controlling the particle size of the diffusion alloy within a reasonable range not only facilitates uniform distribution on the diffusion surface, but also inhibits oxidation. The adhesion surface of diffusion alloy is limited to the surfaces which are perpendicular to the orientation direction, i.e. that the diffusion elements will penetrate into the base magnet along the direction parallel to the orientation direction. There is more grain boundary phase along the orientation direction according to recent research results.

Another aspect of the present invention refers to a high-performance sintered NdFeB magnet which is produced by the before-mentioned method. In the final diffused magnet, a microstructure is formed, wherein terbium and/or dysprosium are introduced by the diffusion process at the periphery of the main phase grains and are located within the distribution area of praseodymium, which is also introduced by diffusion process. Specifically, terbium and/or dysprosium may be present up to a depth of 400 μm or more from the diffusion surface of the magnet. In the microstructure of the diffused magnet, depth of the heavy rare earth elements introduced by diffusion exceeds 400 μm, and a shell structure of praseodymium and heavy rare earth elements is formed on the periphery of the main phase grains. The coercivity get much higher without huge loss of remanence by this method.

### BRIEF DESCRIPTION OF THE DRAWINGS

Features will become apparent to those of ordinary skill in the art by describing in detail exemplary embodiments with reference to the attached drawings in which:

FIG. 1-1 is Tb element EDS mapping in example 1;

FIG. 1-2 is Pr element EDS mapping in example 1;

FIG. 2-1 is Tb element EDS mapping in example 2;

FIG. 2-2 is Pr element EDS mapping in example 2;

FIG. 3-1 is Tb element EDS mapping in example 3;

FIG. 3-2 is Pr element EDS mapping in example 3;

FIG. 4-1 is Dy element EDS mapping in example 4;

FIG. 4-2 is Pr element EDS mapping in example 4;

FIG. 5-1 is Tb+Dy element EDS mapping in example 5;

FIG. 5-2 is Pr element EDS mapping in example 5;

FIG. 6-1 is Tb element EDS mapping in comparative example 3;

FIG. 6-2 is Pr element EDS mapping in comparative example 3;

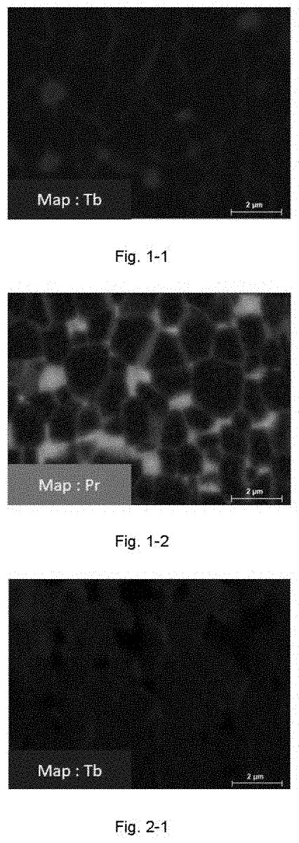

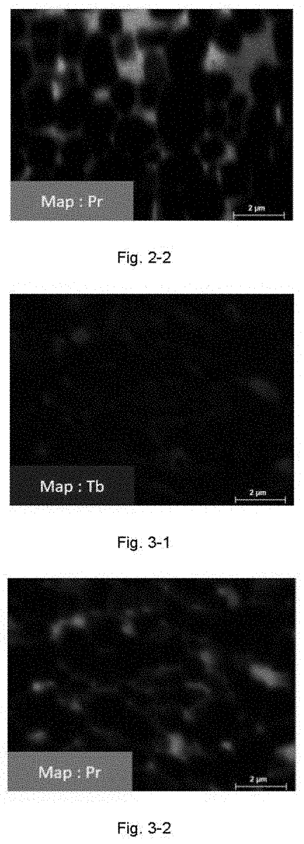

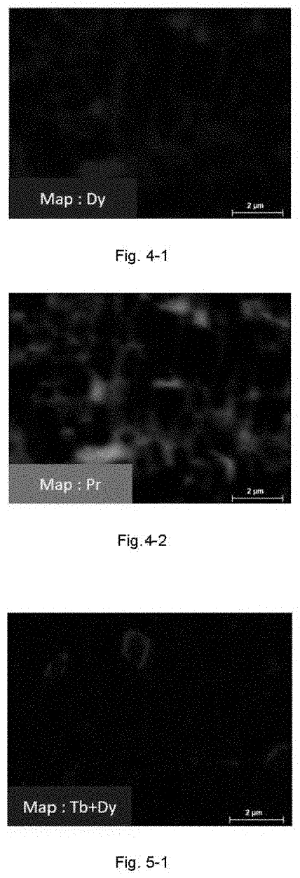

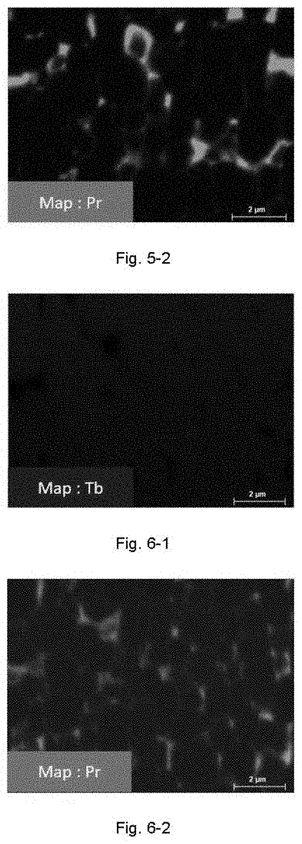

### DETAILED DESCRIPTION

Reference will now be made in detail to embodiments, examples of which are illustrated in the accompanying drawings. Effects and features of the exemplary embodiments, and implementation methods thereof will be described with reference to the accompanying drawings. In the drawings, like reference numerals denote like elements, and redundant descriptions are omitted. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

Generally, there is provided a method for preparing high-performance sintered NdFeB magnets comprising the steps of:

a) attaching a multi-element alloy powder onto a surface of the sintered NdFeB magnet, wherein the multi-element alloy is of formula (1)

PrₐRH_{b}Ga_{c}Cu_{d} (1)

with RH being at least one element selected from dysprosium Dy and terbium Tb and a, b, c, and d satisfying the conditions 0.30≤(a+b)/(a+b+c+d)≤0.65, 0.20≤d/(c+d)≤0.50, and 0.23≤b/(a+b)≤0.60; and
b) performing a diffusion process.

The multi-element alloy powder may be prepared by melting the raw material according to the atomic ratio of the composition in, for example, a vacuum induction furnace. By vacuum spinning multi-element alloy flakes ca be produced. The multi-element alloy flakes are crushed into powders and then attached onto the surface of the neodymium iron boron sintered magnet as diffusion source. Crushing is performed such that an average particle size of the powders is 10 μm to 1000 μm, in particular 50 μm to 600 μm.

The average particle diameter of the particles may be for example measured by a laser diffraction device using appropriate particle size standards. Specifically, the laser diffraction device is used to determine the particle diameter distribution of the particles, and this particle distribution is used to calculate the arithmetic average of particle diameters.

The multi-element alloy powder is preferably attached onto a surface of the magnet which perpendicular to the (magnetic) orientation direction.

Then, a high-temperature diffusion treatment and low-temperature aging treatment is performed in a furnace under vacuum or inert conditions to obtain a diffused neodymium iron boron sintered magnet. Said step of high-temperature diffusion is characterized by a diffusion temperature in the range of 720° C. to 980° C. with a duration time of 5 of 25 hours. Directly following the high-temperature treatment or after a short timely delay of cooling down the magnet to a temperature in the range of 20° C. to 400° C., the low-temperature aging treatment is performed at an aging temperature in the range of 480° C. to 680° C. with a duration time of 1 to 10 hours.

To have a better understanding of the present disclosure, the examples set forth below provide illustrations of the present disclosure. The examples are only used to illustrate the present disclosure and do not limit the scope of the present disclosure.

### Example 1

A vacuum induction furnace is charged with a raw material consisting of Pr50Tb15Ga28Cu7 (atomic ratio) and the molten alloy is made into alloy flakes by a vacuum spinning. The alloy flakes are crushed into a powder with an average particle size of 1000 μm. 2.0 wt. % of the powder is attached to a surface of a sintered NdFeB magnet which perpendicular to the orientation direction. The sintered NdFeB magnet is a N55 grade magnet prepared by a conventional process. The thickness of magnet sample in the diffusion direction is 4.0 mm. The initial performance is Br 1.505 T, Hcj 756.0 kA/m, squareness (Hk/Hcj) 0.95, and the magnet contains Nd, Fe, B, Cu, Co and other elements.

A vacuum heating furnace is used for heat treatment of the powder coated magnet, wherein diffusion is performed at a temperature of 720° C. for 25 hours and subsequently aging is performed at a temperature of 480° C. for 10 hours.

The magnetic properties of the diffused samples are measured, and the element distribution in the depth of 400 to 411 μm from the diffused surface is detected using EDS (X-ray energy spectrometer).

### Example 2

The procedure was carried out as in Example 1, but with the following differences:

The powder consists of Pr12Tb18Ga35Cu35 having an average particle size of 10 μm. Diffusion is performed at a temperature of 980° C. for 5 hours and aging is performed at a temperature of 680° C. for 1 hour.

### Example 3

The procedure was carried out as in Example 1, but with the following differences:

The powder consists of Pr30Tb20Ga35Cu15 having an average particle size of 50 μm. Diffusion is performed at a temperature of 900° C. for 10 hours and aging is performed at a temperature of 520° C. for 3 hours.

### Example 4

The procedure was carried out as in Example 1, but with the following differences:

The powder consists of Pr30Dy20Ga35Cu15 having an average particle size of 600 μm. Diffusion is performed at a temperature of 900° C. for 10 hours and aging is performed at a temperature of 520° C. for 3 hours.

### Example 5

The procedure was carried out as in Example 1, but with the following differences:

The powder consists of Pr30Tb10Dy10Ga35Cu15 having an average particle size of 300 μm. Diffusion is performed at a temperature of 900° C. for 10 hours and aging is performed at a temperature of 520° C. for 3 hours.

Table 1 summarizes the compositions and heavy rare earth contents of the diffusion powders used in Examples 1-5.

TABLE 1

| | Pr | Tb | Cu | Ga | Dy | Pr + Tb + Dy | (Tb + Dy)/ | |
|---|---|---|---|---|---|---|---|---|
| example | (at. %) | (at. %) | (at. %) | (at. %) | (at. %) | (at. %) | (Pr + Tb + Dy) | Cu/(Ga + Cu) |
| 1 | 50.00 | 15.00 | 7.00 | 28.00 | 0.00 | 65.00 | 0.23 | 0.20 |
| 2 | 12.00 | 18.00 | 35.00 | 35.00 | 0.00 | 30.00 | 0.60 | 0.50 |
| 3 | 30.00 | 20.00 | 15.00 | 35.00 | 0.00 | 50.00 | 0.40 | 0.30 |
| 4 | 30.00 | 0.00 | 15.00 | 35.00 | 20.00 | 50.00 | 0.40 | 0.30 |
| 5 | 30.00 | 10.00 | 15.00 | 35.00 | 10.00 | 50.00 | 0.40 | 0.30 |

Table 2 lists the magnetic performance of the treated magnets according to Example 1-5.

TABLE 2

| example | Br (T) | Hcj(kA/m) | Hk/Hcj | ΔHcj(kA/m) | ΔBr(T) | Dy + Tb(wt. %) |
|---|---|---|---|---|---|---|
| 1 | 1.484 | 1846.2 | 0.94 | 1090.2 | −0.021 | 0.40 |
| 2 | 1.475 | 1928.2 | 0.95 | 1172.2 | −0.030 | 0.62 |
| 3 | 1.476 | 1921.8 | 0.95 | 1165.8 | −0.029 | 0.59 |
| 4 | 1.475 | 1460.2 | 0.93 | 704.3 | −0.030 | 0.60 |
| 5 | 1.482 | 1636.1 | 0.94 | 880.1 | −0.023 | 0.59 |

### Comparative Example 1

The procedure was carried out as in Example 1, but with the following differences:

The powder consists of Tb70Cu30 having an average particle size of 300 μm. Diffusion is performed at a temperature of 900° C. for 10 hours and aging is performed at a temperature of 520° C. for 3 hours.

### Comparative Example 2

The procedure was carried out as in Example 1, but with the following differences:

The powder consists of Pr70Ga20Cu10 having an average particle size of 300 μm. Diffusion is performed at a temperature of 900° C. for 10 hours and aging is performed at a temperature of 520° C. for 3 hours.

### Comparative Example 3

The procedure was carried out as in Example 1, but with the following differences:

The powder consists of Pr20Tb5Ga35Cu40 having an average particle size of 300 μm. Diffusion is performed at a temperature of 900° C. for 10 hours and aging is performed at a temperature of 520° C. for 3 hours.

Table 3 summarizes the compositions and heavy rare earth contents of the diffusion powders used in Comparative Examples 1-3.

TABLE 3

| Comparative | Pr | Tb | Cu | Ga | Dy | Pr + Tb + Dy | (Tb + Dy)/ | |
|---|---|---|---|---|---|---|---|---|
| example | (at. %) | (at. %) | (at. %) | (at. %) | (at. %) | (at. %) | (Pr + Tb + Dy) | Cu/(Ga + Cu) |
| 1 | 0.00 | 70.00 | 30.00 | 0.00 | 0.00 | 70.00 | 1.00 | 1.00 |
| 2 | 70.00 | 0.00 | 10.00 | 20.00 | 0.00 | 70.00 | 0.00 | 0.33 |
| 3 | 20.00 | 5.00 | 40.00 | 35.00 | 0.00 | 25.00 | 0.20 | 0.53 |

Table 4 lists the magnetic performance of the treated magnets of Comparative Examples 1-3.

TABLE 4

| comparative | | | | | | |
|---|---|---|---|---|---|---|
| example | Br (T) | Hcj(kA/m) | Hk/Hcj | ΔHcj(kA/m) | ΔBr(T) | Dy + Tb(wt. %) |
| 1 | 1.420 | 1691.0 | 0.87 | 935.0 | −0.085 | 1.71 |
| 2 | 1.461 | 1136.4 | 0.94 | 380.4 | −0.044 | 0.00 |
| 3 | 1.475 | 1235.8 | 0.93 | 479.9 | −0.030 | 0.18 |

According to the results of Examples 1 to 5, it can be concluded that with the infiltration amount of heavy rare earth no more than 0.62% by weight, the coercivity increased over 704.3 kA/m after diffusion, and the remanence is not less than 1.475 T. Even when a low amount of heavy rare earth is used, a significant increase in coercivity is achieved without causing a significant decrease in remanence.

EDS (X-ray energy spectrometer) results showed that the diffusion depth of heavy rare earth elements exceeds 400 μm. Praseodymium and heavy rare earth elements formed a shell structure on the periphery of the main phase grains. In said shell structure, the distribution range of heavy rare earth elements does not exceed the distribution range of praseodymium. This structure not only increases the magnetocrystalline anisotropy field of the main phase grains, but also avoids heavy rare earth elements infiltrating into the centre of the main phase grains. That means, the coercivity increases obviously without large loss of remanence after diffusion.

Comparative Example 1 uses a terbium-copper binary alloy to diffuse into the base magnet. Although the coercivity is greatly improved after diffusion, the infiltration amount of heavy rare earth is too high and exceeds 1.7% by weight. At the same time, the remanence reduction value is as high as 0.085 T. The method of Comparative Example 1 therefore has low comprehensive performance and high raw material costs.

Comparative Example 2 uses a praseodymium-copper-gallium ternary alloy as a diffusion source. The low melting point makes the diffusion depth of each element in the diffusion process larger and the microstructure is more uniform. But because the diffusion source does not contain heavy rare earth elements, a shell structure with higher magnetocrystalline anisotropy fields in the grain boundaries is not formed. That results in only a small increase of coercivity.

In Comparative Example 3 a praseodymium-terbium-copper-gallium quaternary alloy is used, wherein the proportion of praseodymium and terbium in the alloy is relatively low, which however decreases the driving energy for diffusion. In particular, terbium cannot be detected in a depth of 400 μm and more according to the EDS mapping result. As a consequence, coercivity increase is limited.

In summary, the present invention provided a method for preparing NdFeB magnets magnet with higher magnetic performance and improved microstructure.

What is claimed is:

1. A method for preparing high-performance sintered NdFeB magnets comprising the steps of:
a) attaching a multi-element alloy powder onto a surface of the sintered NdFeB magnet, wherein the multi-element alloy is of formula (1)
PrₐRH_{b}Ga_{c}Cu_{d} (1)
with RH being at least one element selected from Dy and Tb and
a, b, c, and d satisfying the conditions 0.30≤(a+b)/(a+b+c+d)≤0.65, 0.20≤d/(c+d)≤0.50, and 0.23≤b/(a+b)≤0.60; and
b) performing a diffusion process.

2. The method of claim 1, wherein in the diffusion process of step b) a diffusion temperature is in the range of 720° C. to 980° C. for a period of 5 to 25 hours.

3. The method of claim 1, wherein step b) is followed by step c) of performing an aging process.

4. The method of claim 2, wherein step b) is followed by step c) of performing an aging process.

5. The method of claim 3, wherein in the aging process of step c) an aging temperature is in the range of 480° C. to 680° C. for a period of 1 to 10 hours.

6. The method of claim 4, wherein in the aging process of step c) an aging temperature is in the range of 480° C. to 680° C. for a period of 1 to 10 hours.

7. The method of claim 1, wherein an average particle size of the multi-element alloy powder is in the range of 10 μm to 1000 μm.

8. The method of claim 7, wherein the average particle size of the powder is 50 μm to 600 μm.

9. The method of claim 2, wherein an average particle size of the multi-element alloy powder is in the range of 10 μm to 1000 μm.

10. The method of claim 9, wherein the average particle size of the powder is 50 μm to 600 μm.

11. The method of claim 3, wherein an average particle size of the multi-element alloy powder is in the range of 10 μm to 1000 μm.

12. The method of claim 11, wherein the average particle size of the powder is 50 μm to 600 μm.

13. The method of claim 4, wherein an average particle size of the multi-element alloy powder is in the range of 10 μm to 1000 μm.

14. The method of claim 13, wherein the average particle size of the powder is 50 μm to 600 μm.

15. The method of claim 1, wherein in step a) the multi-element alloy powder is attached to a surface which perpendicular to the orientation direction of the sintered NdFeB magnet.

16. The method of claim 2, wherein in step a) the multi-element alloy powder is attached to a surface which perpendicular to the orientation direction of the sintered NdFeB magnet.

17. The method of claim 3, wherein in step a) the multi-element alloy powder is attached to a surface which perpendicular to the orientation direction of the sintered NdFeB magnet.

18. The method of claim 4, wherein in step a) the multi-element alloy powder is attached to a surface which perpendicular to the orientation direction of the sintered NdFeB magnet.

19. The method of claim 5, wherein in step a) the multi-element alloy powder is attached to a surface which perpendicular to the orientation direction of the sintered NdFeB magnet.

20. A high-performance sintered NdFeB magnet produced by the method according to claim 1.
